(19) United States
(12) Patent Application Publication
(10) Pub. No.: US 2026/0120914 A1
(43) Pub. Date: Apr. 30, 2026

(54) ELECTRICALLY CONDUCTIVE STRUCTURE OF MASSAGE HEAD

(71) Applicant: Zhejiang Red and Black Technology Co., Ltd, Lishui (CN)

(72) Inventors: Xinyi Shu, Jinyun County (CN); Lifeng Shu, Jinyun County (CN)

(21) Appl. No.: 18/959,513

(22) Filed: Nov. 25, 2024

(30) Foreign Application Priority Data
Oct. 25, 2024 (CN) 2024225982658

(51) Int. Cl. H01B 5/00; A61H 23/00; A61H 23/02

(52) U.S. Cl. CPC H01B 5/006; A61H 23/006; A61H 23/02

(57) ABSTRACT

An electrically conductive structure of a massage head includes a body, a sheet-like conductive member, a conductive post, and a limiting member. A mounting groove is provided on the body, a plurality of limiting posts are disposed on a wall of the mounting groove, a first limiting groove matching the limiting post is provided at an edge of the sheet-like conductive member, a second limiting groove matching the conductive post is provided on the limiting member. When the limiting member is disposed inside the mounting groove, the conductive post is electrically connected to the sheet-like conductive member. Due to the combination of the sheet-like conductive member and the conductive post, a connection structure of a circuit is simplified. Therefore, a structure of a conventional circuit board that is easily damaged can be replaced. The electrically conductive structure has better anti-vibration performance and is not easily damaged because of vibration.

### TECHNICAL FIELD

The present disclosure relates to a field of percussion massagers, and in particular to an electrically conductive structure of a massage head.

### BACKGROUND

As a popular fitness and relaxation tool, the design of an internal structure of a percussion massager is crucial to user experience, stability of performance, and durability.

Due to the frequent vibration of the percussion massager, small components and circuits on a circuit board are easily damaged after being used for a long time or in a high-intensity vibration environment. As a result, performance is reduced or even becomes ineffective.

### SUMMARY

In view of this, it is necessary to provide an electrically conductive structure of a massage head to resolve the above problem. The electrically conductive structure of a massage head is applied to a percussion massager and includes a body, a sheet-like conductive member, a conductive post, and a limiting member, where a mounting groove is provided on the body, a plurality of limiting posts are disposed on a wall of the mounting groove, a first limiting groove matching the limiting post is provided at an edge of the sheet-like conductive member, a second limiting groove matching the conductive post is provided on the limiting member, and when the limiting member is disposed inside the mounting groove, the conductive post is electrically connected to the sheet-like conductive member.

Preferably, there are three conductive posts.

Preferably, the sheet-like conductive member is a copper sheet.

Preferably, two annular grooves are provided on a surface of the sheet-like conductive member, and the annular groove at an outer circle is larger than the annular groove at an inner circle.

Preferably, a connection groove is provided on the limiting member, and a plurality of threaded holes are provided on the connection groove.

Preferably, a retention hole is provided on the mounting groove.

Preferably, an edge of a bottom of the sheet-like conductive member between two first limiting grooves is upturned in a shape of a hook, and when the sheet-like conductive member is disposed inside the mounting groove, the mounting groove is embedded at the edge of the bottom of the sheet-like conductive member that is in the shape of the hook.

Preferably, the limiting posts are oppositely disposed one above the other and oppositely disposed on left and right.

### BRIEF DESCRIPTION OF THE DRAWINGS

FIG. 1 is a schematic diagram of a structure of an electrically conductive structure of a massage head according to an embodiment of the present disclosure;

FIG. 2 is an exploded view of an electrically conductive structure of a massage head according to an embodiment of the present disclosure;

FIG. 3 is a schematic diagram of a structure of a body at a first viewing angle according to an embodiment of the present disclosure;

FIG. 4 is a schematic diagram of a structure of a body at a second viewing angle according to an embodiment of the present disclosure;

FIG. 5 is an enlarged view of a position A shown in FIG. 4;

FIG. 6 is a schematic diagram of a connection between a limiting member and a sheet-like conductive member according to an embodiment of the present disclosure;

FIG. 7 is a schematic diagram of a structure of a limiting member according to an embodiment of the present disclosure; and

FIG. 8 is a schematic diagram of a structure that a conductive post is connected to a sheet-like conductive member according to an embodiment of the present disclosure.

Reference numerals: 1: body; 11: mounting groove; 12: limiting post; 13: retention hole; 2: sheet-like conductive member; 21: first limiting groove; 22: annular groove; 3: conductive post; 4: limiting member; 41: second limiting groove; 42: connection groove; 43: threaded hole.

### DETAILED DESCRIPTION OF THE EMBODIMENTS

To make the objectives, technical solutions and the advantages of the present disclosure clearer, an electrically conductive structure of a massage head provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

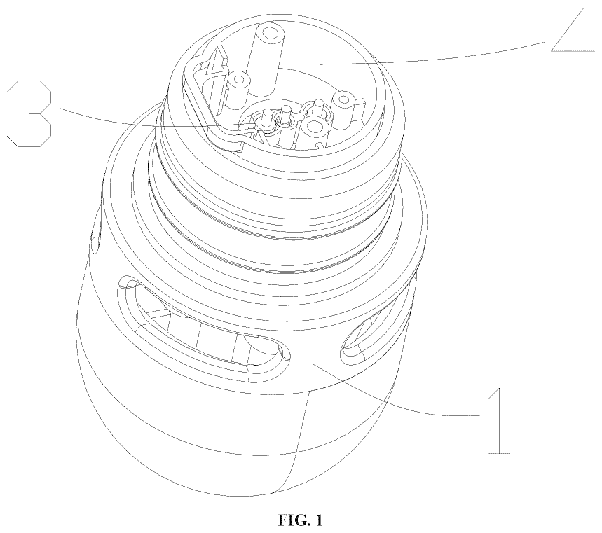

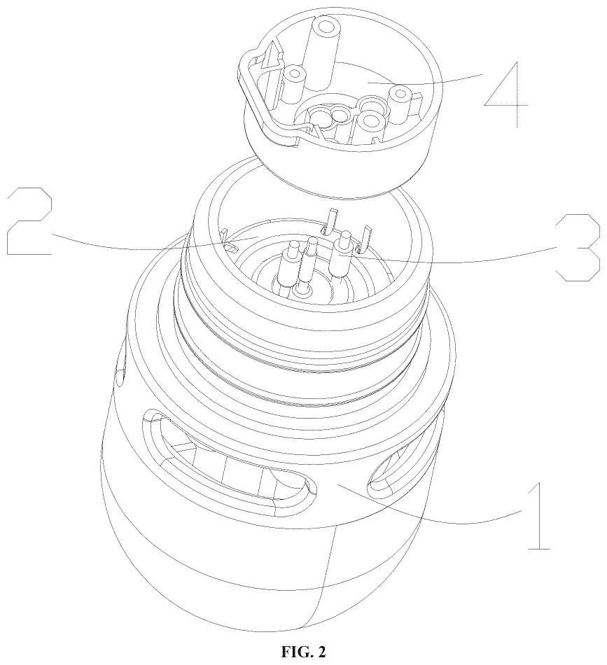

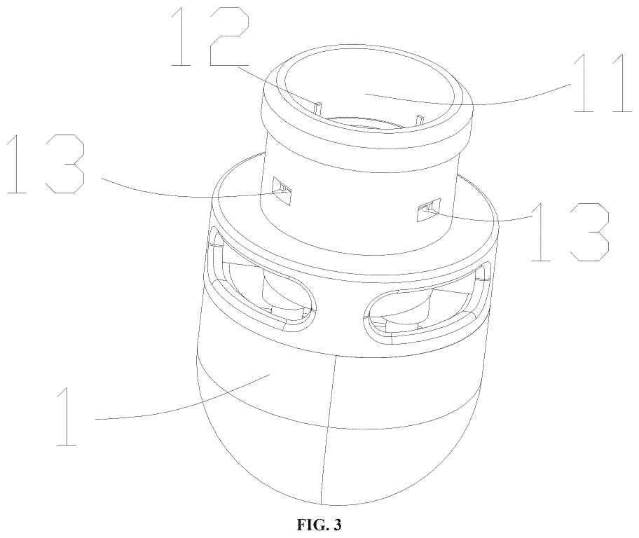

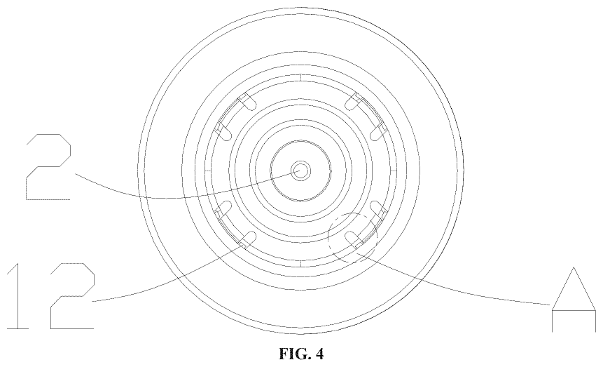

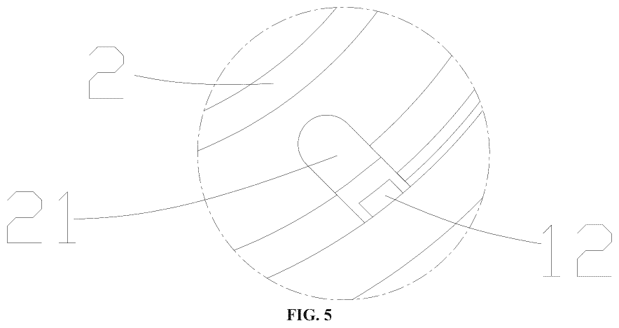

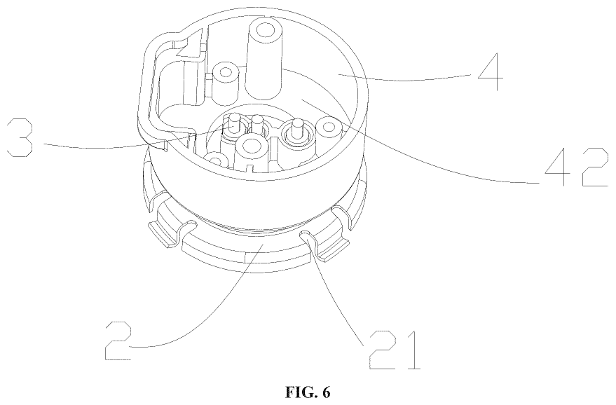

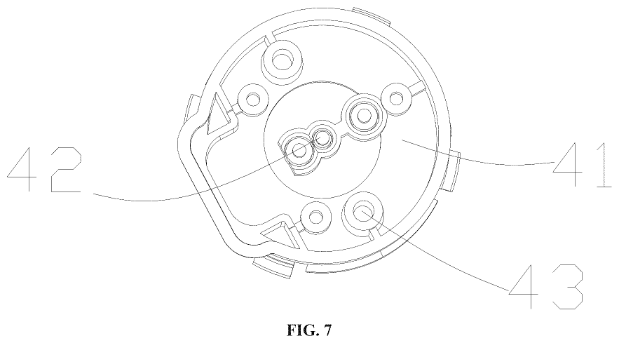

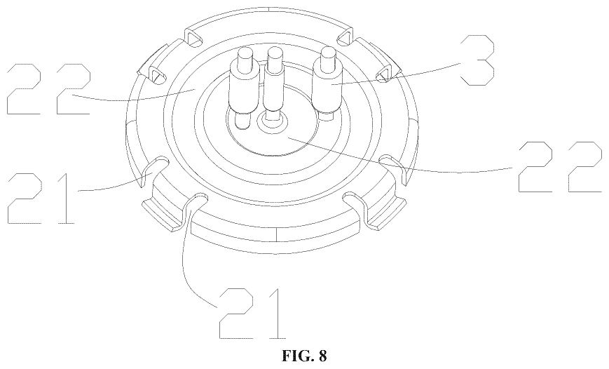

Referring to FIG. 1 to FIG. 8, an electrically conductive structure of a massage head provided in the embodiments of the present disclosure is applied to a percussion massager and includes a body 1, a sheet-like conductive member 2, a conductive post 3, and a limiting member 4. A mounting groove 11 is provided on the body 1, a plurality of limiting posts 12 are disposed on a wall of the mounting groove 11, a first limiting groove 21 matching the limiting post 12 is provided at an edge of the sheet-like conductive member 2, and a second limiting groove 41 matching the conductive post 3 is provided on the limiting member 4. When the limiting member 4 is disposed inside the mounting groove 11, the conductive post 3 is electrically connected to the sheet-like conductive member 2.

In this embodiment, due to the combination of the sheet-like conductive member 2 and the conductive post 3, a connection structure of a circuit is simplified. Therefore, a structure of a conventional circuit board that is easily damaged can be replaced. The electrically conductive structure of a massage head includes four parts, namely, the body 1, the sheet-like conductive member 2, the conductive post 3, and the limiting member 4. Cooling and heating functions of the body are enabled by connecting any two of the conductive posts 3 to the sheet-like conductive member 2.

As a support frame of the electrically conductive structure of a massage head, the mounting groove 11 is provided on the body 1, to accommodate and fix the limiting member 4. The plurality of limiting posts 12 are disposed on the wall of the mounting groove 11, to limit the sheet-like conductive member 2. As a component for electrical conduction, the first limiting groove 21 matching the limiting post 12 is provided at the edge of the sheet-like conductive member 2, to implement a solid mounting by a plugging simply, and ensure a smooth transmission of electrical signals.

To further enhance solidity of the connection and reliability of the electrical conduction, the limiting member 4 is disposed. The second limiting groove 41 matching the conductive post 3 is provided on the limiting member 4. When the limiting member 4 is mounted inside the mounting groove 11 of the body 1, the conductive post 3 may be inserted into the second limiting groove 41. This limits the conductive post 3 and implements an electrical connection with the sheet-like conductive member 2. This design simplifies the electrical connection, and greatly reduces poor contact caused by vibration.

Due to the combination of the sheet-like conductive member 2 and the conductive post 3 and the firmly limiting of the limiting member 4, the electrically conductive structure of a massage head has better anti-vibration performance and is not easily damaged because of vibration. In addition, the limiting member 4 further enhances the solidity of the connection, to enable the entire electrical connection system to stably work in a harsh working environment, thereby significantly improving durability and reliability of the percussion massager.

Referring to FIG. 1 to FIG. 8, in another embodiment, there are three conductive posts 3. The sheet-like conductive member 2 is a copper sheet. Two annular grooves 22 are provided on a surface of the sheet-like conductive member, and the annular groove 22 at an outer circle is larger than the annular groove 22 at an inner circle.

In this embodiment, there are three conductive posts 3 that are all located inside the mounting groove 11 of the body 1, to establish an electrical connection with the sheet-like conductive member 2 and an external component. The sheet-like conductive member 2 is made of a high-quality copper sheet, to guarantee stable transmission of the electrical signals via good conductivity and durability of the sheet-like conductive member 2.

The two annular grooves 22 are provided on the copper sheet, and a diameter of the circular groove at the outer circle is larger than a diameter of the circular groove at the inner circle. The two conductive posts 3 are in contact with the copper sheet, and one conductive post 3 is avoided corresponding to the annular groove 22. When an ordinary massage head is mounted in a main machine, the two conductive posts 3 may be connected to each other, while a third conductive post 3 is maintained at an avoidance state and does not participate in a current electrical connection. This implements a function of sensing whether the massage head is mounted. To be specific, when the massage head is correctly mounted, a corresponding electrical signal is triggered by the two conductive posts 3 that are connected to each other, to start or adjust a working mode of the percussion massager. If the massage head is not mounted or is improperly mounted, the conductive post 3 that is avoided stays unchanged, to prevent a device from being misoperated or damaged.

Referring to FIG. 1 to FIG. 8, in another embodiment, a connection groove 42 is provided on the limiting member 4, and a plurality of threaded holes 43 are provided on the connection groove 42.

In this embodiment, the plurality of threaded holes 43 are provided on the connection groove 42, to fit with the massage head. When the massage head needs to be mounted to the main machine, a connection part of the massage head is first aligned with the connection groove 42 of the limiting member 4, and then locked via a screw.

Referring to FIG. 1 to FIG. 8, in another embodiment, a retention hole 13 is provided on the mounting groove 11. An edge of a bottom of the sheet-like conductive member 2 between two first limiting grooves 21 is upturned in a shape of a hook. When the sheet-like conductive member 2 is disposed inside the mounting groove 11, the mounting groove 11 is embedded at the edge of the bottom of the sheet-like conductive member 2 that is in the shape of the hook.

In this embodiment, the edge of the bottom of the sheet-like conductive member 2 is upturned between the two first limiting grooves 21, to form a hook-like structure. This enables the sheet-like conductive member 2 to be more tightly attached in the mounting groove 11 during mounting. When the sheet-like conductive member 2 is placed into the mounting groove 11, the edge of the bottom of the sheet-like conductive member 2 that is in the shape of the hook is naturally embedded in the retention hole 13 of the mounting groove 11. This embedded connection increases a contact area between the sheet-like conductive member 2 and the mounting groove 11, and effectively prevents the sheet-like conductive member 2 from moving or falling off under vibration or an external force in a physical locking manner.

Referring to FIG. 1 to FIG. 8, the limiting posts 12 are oppositely disposed one above the other and oppositely disposed on left and right.

The limiting posts 12 that are oppositely disposed one above the other play a limiting role in a vertical direction. The limiting posts are located at a top and a bottom of the mounting groove 11 respectively, and are in close contact with a top edge and a bottom edge of the sheet-like conductive member 2, to prevent the sheet-like conductive member 2 from offsetting or shaking in the vertical direction. This design ensures vertical stability of the sheet-like conductive member 2 inside the mounting groove 11.

In addition, the limiting posts 12 that are oppositely disposed on left and right play a limiting role in a horizontal direction. The limiting posts 12 are symmetrically disposed on a left side and a right side of the mounting groove 11 and are accurately aligned with the first limiting groove 21 at an edge of the sheet-like conductive member 2. When the sheet-like conductive member 2 is placed into the mounting groove 11, the limiting posts 12 are naturally embedded in the first limiting groove 21, to limit the sheet-like conductive member 2 in the horizontal direction. This design ensures stability and accuracy of the sheet-like conductive member 2 in the horizontal direction.

In conclusion, because the limiting posts 12 are oppositely disposed one above the other and oppositely disposed on left and right, full-range limitation and support are provided for the sheet-like conductive member 2, and the limiting posts 12 are uniformly stressed in the mounting groove 11. This design effectively prevents the sheet-like conductive member 2 from offsetting and shaking during mounting and use, and improves stability and reliability of the electrical connection.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. An electrically conductive structure of a massage head, applied to a percussion massager, comprising a body, a sheet-like conductive member, a conductive post, and a limiting member, wherein a mounting groove is provided on the body, a plurality of limiting posts are disposed on a wall of the mounting groove, a first limiting groove matching the limiting post is provided at an edge of the sheet-like conductive member, a second limiting groove matching the conductive post is provided on the limiting member, and when the limiting member is disposed inside the mounting groove, the conductive post is electrically connected to the sheet-like conductive member.

2. The electrically conductive structure of a massage head according to claim 1, wherein there are three conductive posts.

3. The electrically conductive structure of a massage head according to claim 2, wherein the sheet-like conductive member is a copper sheet.

4. The electrically conductive structure of a massage head according to claim 3, wherein two annular grooves are provided on a surface of the sheet-like conductive member, and the annular groove at an outer circle is larger than the annular groove at an inner circle.

5. The electrically conductive structure of a massage head according to claim 1, wherein a connection groove is provided on the limiting member, and a plurality of threaded holes are provided on the connection groove.

6. The electrically conductive structure of a massage head according to claim 3, wherein a retention hole is provided on the mounting groove.

7. The electrically conductive structure of a massage head according to claim 6, wherein an edge of a bottom of the sheet-like conductive member between two first limiting grooves is upturned in a shape of a hook, and when the sheet-like conductive member is disposed inside the mounting groove, the mounting groove is embedded at the edge of the bottom of the sheet-like conductive member that is in the shape of the hook.

8. The electrically conductive structure of a massage head according to claim 1, wherein the limiting posts are oppositely disposed one above the other and oppositely disposed on left and right.
